(19) United States
(12) Patent Application Publication
(10) Pub. No.: US 2015/0370490 A1
(43) Pub. Date: Dec. 24, 2015

(54) OPTIMIZING SSD-BASED CONTENT CACHES IN CONTENT DELIVERY NETWORKS

(71) Applicant: NEC Europe Ltd., Heidelberg (DE)

(72) Inventors: Felipe Huici, Dossenheim (DE); Mohamed Ahmed, Heidelberg (DE); Saverio Niccolini, Neckargemuend (DE)

(21) Appl. No.: 14/312,721

(22) Filed: Jun. 24, 2014

(51) Int. Cl. G06F 3/06; G06F 12/08

(52) U.S. Cl. CPC G06F 3/0611; G06F 12/0888; G06F 12/0891; G06F 3/0652; G06F 3/0656; G06F 3/0679; G06F 2212/1024; G06F 2212/152; G06F 2212/2022; G06F 2212/214; G06F 2212/222; G06F 2212/305; G06F 2212/604; G06F 2212/7205

(57) ABSTRACT

A method for caching using a solid-state drive (SSD)-based cache includes: determining a set of potential objects for storage at the SSD-based cache; ranking the potential objects for storage based on expected utility values corresponding to each potential object for storage; selecting objects for storage from the potential objects for storage based on the ranking; and causing the selected objects to be written to the SSD-based cache. Further, a reserve capacity for the SSD-based cache may be dynamically adjusted based on the write speed associated with an object being written to the SSD-based cache.

### BACKGROUND

Growth in consumer Internet traffic is being driven by an increase in demand for multimedia traffic and the use of mobile devices, resulting in a need to provide infrastructure that supports a good quality of experience for content consumers (e.g., low buffering times). It is expected that the demand for video and other multimedia traffic will continue to increase, as will the need for content delivery networks (CDNs) to deliver such traffic.

One of the building blocks of CDNs is the content caches, which are content servers placed throughout the network in locations that are closer to users than content origin servers. Because the caches are able to handle user requests locally, it is desirable for the CDN to have content caching algorithms such that content desired by users is available at a cache, and to provide such content from the cache in a quick and efficient manner.

An emerging technology that has been used to achieve quick and efficient provision of cached contents is Solid State Drive (SSD)-based caching. Because SSDs are essentially arrays of gates and, unlike hard drives, do not contain moving parts, accessing data stored on SSDs is both fast and consistent (i.e., the time taken to access a particular piece of data is constant because there are no seek penalties).

However, SSD caches have problems associated therewith. While read operations on an SSD are fast, write operations are relatively slow (e.g., in one example an SSD drive was found to have a maximum read performance of 415 MB/sec but only 175 MB/sec for write), and data from the SSD must be erased prior to new data being written. Additionally, each write operation reduces the lifetime of the SSD gates that were written to, and given enough writes, the gates are no longer able to be rewritten.

### SUMMARY

In an embodiment, the invention provides a method for caching using a solid-state drive (SSD)-based cache. The method includes: determining, by a controller, a set of potential objects for storage at the SSD-based cache; ranking, by the controller, the potential objects for storage based on a respective expected utility value corresponding to each potential object for storage; selecting, by the controller, objects for storage from the potential objects for storage based on the ranking; and causing, by the controller, the selected objects to be written to the SSD-based cache.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a block diagram that illustrates an exemplary CDN environment;

FIG. 2 is a flowchart illustrating an exemplary process for preparing an SSD cache for a write operation in an exemplary embodiment; and

FIG. 3 is flowchart illustrating an exemplary process for writing contents to an SSD cache in an exemplary embodiment.

### DETAILED DESCRIPTION

Embodiments of the invention provide systems and methods for optimizing the performance of SSD-based caches by using a utility measure based on content popularity estimations (with consideration of uncertainties associated therewith as error bounds), which is particularly suitable for video content applications (e.g., a catalog of videos present in a CDN). The embodiments of the invention achieve the advantages of extending the lifetime of SSD-based caches by minimizing the number of write operations and improving write performance by determining a close-to-optimal amount of space to leave unused in an SSD-based cache.

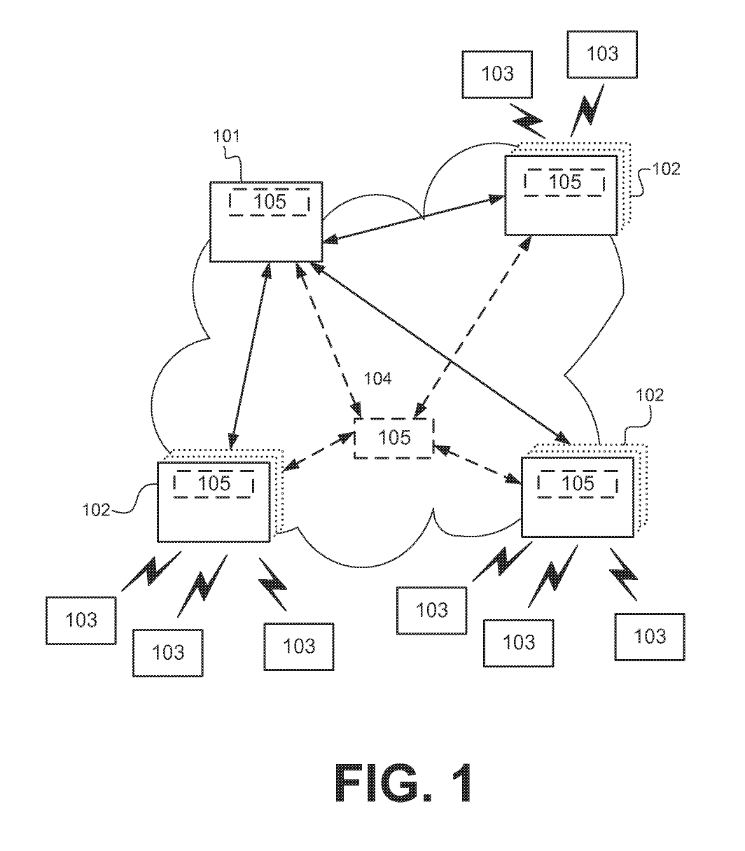

FIG. 1 illustrates components of an exemplary CDN environment including a content origin 101, data centers including one or more SSD-based cache servers 102, and a plurality of computing devices 103 (such as end user personal computers, laptops, tablets, mobile phones, etc.). The content origin 101 is connected to the SSD-based cache servers 102 in a CDN across a network 104 (e.g., the Internet), and computing devices 103 connect to SSD-based cache servers 102 at various geographic locations to efficiently retrieve content provided by the content origin 101 via the SSD-based cache servers 102.

By keeping copies of frequently accessed content (or content expected to be frequently accessed) from the content origin 101 at particular SSD-based cache servers 102 or groups of SSD-based cache servers 102, the computing devices 103 are able to achieve an improved user experience via quicker access and, for example, in the case of streaming video, shorter buffering times. Control of what is stored at each of the SSD-based cache servers 102 or group of SSD-based cache servers 102 is provided by a controller 105 associated with the cache server and/or group of cache servers. In one exemplary embodiment, a controller 105 is implemented locally at each data center and controls what content from the content origin is maintained at the one or more cache servers of that data center. In another exemplary embodiment, centralized and/or distributed control is provided via a remote controller 105 (for example, at the content origin 101 or a standalone controller 105) that provides instructions as to what is to be stored to the cache servers of a particular data center (which may or may not be implemented in combination with local control logic provided by a local controller).

It will be appreciated that servers of the content origin 101 and the SSD-based cache servers 102, as well as the computing devices 103, include processors and non-transitory processor-readable mediums (e.g., RAM, ROM, PROM, volatile, nonvolatile, or other electronic memory mechanism). Operations performed by these components of the CDN and computing devices 103 are carried out according to processor-executable instructions and/or applications stored and/or installed on the non-transitory processor-readable mediums of their respective computing devices. It will further be appreciated that the components of the CDN and computing devices 103 include suitable communications hardware for communicating over a wireless network, for example, a cellular or landline communications network and/or wirelessly via the Internet.

As discussed above, the more write operations are done on an SSD cache, the more the SSD cache's write performance and lifetime decreases. The latter manifests itself in terms of gates that can no longer change their value, effectively becoming read-only. Given enough writes, the SSD becomes a read-only device and its write performance is seriously hindered. Embodiments of the invention provide caching processes by which the number of write operations performed by an SSD cache are kept to a minimum.

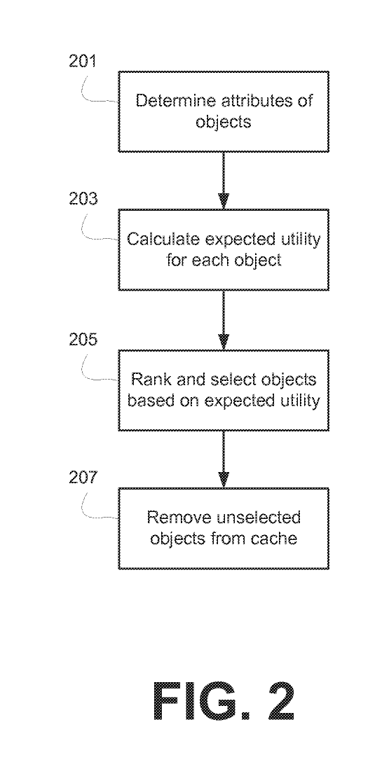

FIG. 2 is a flowchart that illustrates a process for preparing an SSD-based cache for a write operation in an exemplary embodiment. For a set of potential objects to be stored at the SSD-based cache (which may contain objects already written to the SSD-based cache), attributes of each object are determined at stage 201. This includes, for example, the size of each object, the expected number of hits for that object over a time horizon T (i.e., an expected future popularity), and the uncertainty associated with the expected number of hits (i.e., an expected prediction error associated with the expected future popularity). The time horizon T may be a policy-defined value set by the system, and may include several different time horizons—for example, an object's expected popularity (and uncertainty associated therewith) may be considered for different time horizons separately or in the aggregate when determining that object's expected utility relative to other objects.

In different embodiments, the expected number of hits over a time horizon T and the uncertainty associated therewith are obtained in different ways. In one exemplary embodiment, clustering along with maximum likelihood path calculation is used to determine the expected number of hits over a time horizon T, and normalized mean squared prediction error (MSPE) is used to determine uncertainty, for example, as described in Mohamed Ahmed, Stella Spagna, Felipe Huici, and Saverio Niccolini, “A peek into the future: predicting the evolution of popularity in user generated content,” Proceedings of the sixth ACM international conference on Web search and data mining (WSDM 2013), pp. 607-616, DOI=10.1145/2433396.2433473, which is incorporated by reference herein in its entirety.

Based on each object's attributes, an expected utility for each object is calculated at stage 203. In one exemplary embodiment, this calculation may be performed with respect to a particular time horizon T, and a convex and continuously differentiable utility function is used. For example, the following equations may be used in the calculation:

$${U}_{i} = w \text{?} {\sum }_{i = 0}^{T} \text{?} p \text{?}$$

$$\text{?} \text{indicates text missing or illegible when filed}$$

where Uᵢ is the utility for an object, λ is a future discount factor (which is a configurable parameter set by the system that defines the uncertainty corresponding to expected hits in the distant future) between 0 and 1, p is the expected number of hits for the object at time t, and w is an indicator function equal to β>1 if the object is already stored on the drive or equal to 1 if the object is not already stored on the drive (w favors contents already in the cache in order to reduce deletions). It will be appreciated that the value for X may be determined experimentally to obtain an optimal value.

The objects are then ranked (e.g., by sorting them in decreasing order of expected utility for a time period T) and selected to be written into the cache at stage 205. The time period T can be a single time period or an aggregation of multiple time periods. For example, in an exemplary embodiment, T=T′₁, T′₂ . . . T′ₙ such that Σᵢ T′₁=T. The time T (and subdivisions for time T) may be selected based on a period of time that takes into account the system's cache size constraints and delay constraints (and corresponds to an appropriate tradeoff between the desire to keep popular objects stored at the cache versus the desire to minimize cache rewrites).

The ranking and selection of the objects at stage 205 is bound by system policies and constraints. For example, the objects selected to be written is constrained by an amount of disk space to be used. The amount of disk space to be used may be the total capacity of the drive in question or may be otherwise set by the caching system. Thus, when ranking and selecting the objects for a cache, the cumulative size of the selected objects is not to exceed this constraint regarding the amount of disk space to be used.

Another constraint is a quality of service (QoS) requirement that specifies a maximum acceptable latency (which may ensure that achieving high performance and satisfying cache policy is prioritized over minimizing the number of write/delete operations). The caching system may specify a reasonable average delay time for accessing a particular object (e.g., a video). For example, an expected system latency Lₑₓₚ associated with a set of selected objects is constrained to satisfy a policy-defined maximum L_{sys}. In an exemplary embodiment, the expected system latency is calculated according to the following equation:

Lₑₓₚ=(Σᵢ₌₀^{N}lᵢ*hᵢ)/N

where lᵢ is the latency for object i (set by the system operator to a certain value if the object has been selected for the local cache and a higher value if it has to be retrieved from an origin server), hᵢ is the expected number of requests for object i, and N is the total number of objects under consideration for inclusion in the cache. Following this constraint ensures that the cache policy for latency set by the system is still complied with even though the ranking and selection process is aimed at optimizing a number of write/delete cycles.

Various selection criteria can be used. In one exemplary embodiment, the process aims to maximize the expected utility normalized by deviations Uᵢ/varᵢ so as to indicate a preference for objects with smaller expected variance in expected utility. In another exemplary embodiment, the process selects the objects with the highest expected utility (not normalized).

After a set of objects is selected from the original set of potential objects for storage at the SSD-based cache, objects that are not selected are removed from the SSD-based cache at stage 207. After these objects are removed from the SSD-based cache, the SSD-based cache is ready to perform a write operation to write any new objects from the set of selected objects that are not already stored at the SSD-based cache. In certain implementations of embodiments of the invention, existing tools such as TRIM commands may be used to carry out deletions.

An example of the process depicted in FIG. 2 is illustrated below with respect to Tables 1 and 2. Table 1 provides an exemplary illustrative set of objects, identified as objects A-E, with different corresponding expected utility values and sizes associated therewith (determined at stages 201 and 203).

TABLE 1

| Obj. ID | Uᵢ | Size (GB) |
|---|---|---|
| A | 3 | 20 |
| B | 5 | 30 |
| C | 2 | 25 |
| D | 1 | 10 |
| E | 4 | 5 |

At stage 205, the objects are ranked based on expected utility, for example, as shown in Table 2.

TABLE 2

| Obj. ID | Uᵢ | Size (GB) |
|---|---|---|
| B | 5 | 30 |
| E | 4 | 5 |
| A | 3 | 20 |
| C | 2 | 25 |
| D | 1 | 10 |

The objects are then selected for inclusion subject to size and latency constraints. For example, for an SSD cache with 80 GB capacity, objects B, E, A and C are selected for the cache (30 GB+5 GB+20 GB+25 GB=80 GB), but object D is not selected because adding an additional 10 GB would cause the cumulative size of the selected objects to exceed the capacity of the SSD cache.

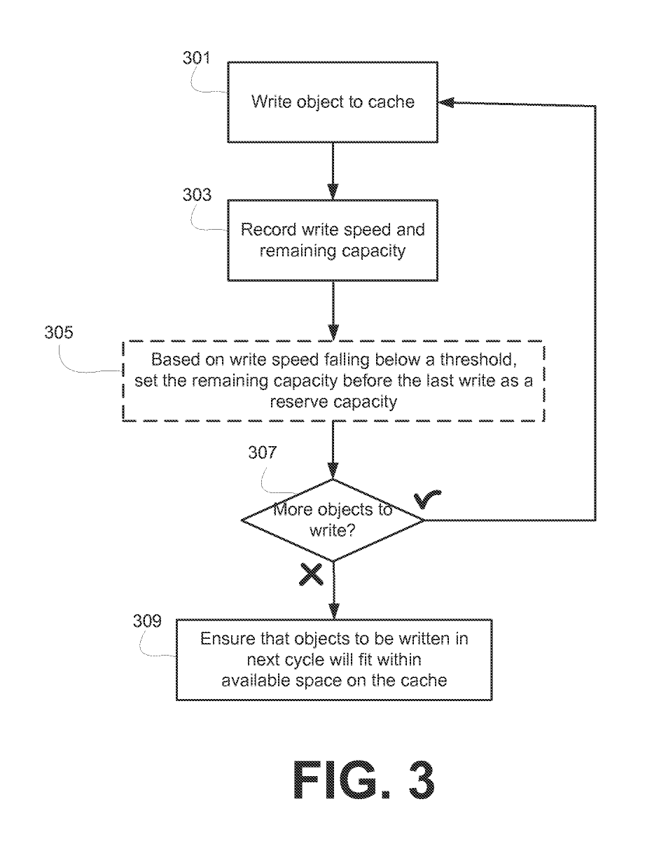

FIG. 3 is a flowchart that illustrates a process for writing contents to the SSD-based cache that allows for dynamically determining an amount of reserved space that the SSD-based cache should maintain for sustaining high write performance. Each object is written to the cache at stage 301. After each object is written, the write speed corresponding to the writing of that object and the remaining capacity of the SSD-based cache after the writing of that object is recorded at stage 303. Objects are written to the cache and the corresponding write speed and capacity information is recorded with respect to one object after another until it is determined at stage 307 that there are no more objects to be written to the cache.

During the process of writing these objects to the cache, in response to the write speed for an object falling below a threshold write speed (indicating a degradation in write performance with respect to write speed), the remaining capacity of the SSD-based cache before that write operation occurred is set as a “reserve capacity” for the SSD-based cache at stage 305. It will be appreciated that stage 305 may be performed immediately in response to determining that the write speed has fallen below the threshold or at some other time in the process (such as after when it is determined that there are no more objects to write at stage 307).

The reserve capacity provides an amount of empty space on the SSD-based cache that should be maintained as empty in order to sustain high write performance that satisfies the threshold write speed. In an example, if the reserve capacity for a 128 GB cache is determined to be 8 GB, the system will designate a constraint of 120 GB with respect to the selection of objects to be cached (as discussed above with respect to FIG. 2). Thus at stage 309, the system ensures that the cumulative size of objects to be stored on the cache for a next time period will not exceed 120 GB (e.g., by placing a 120 GB constraint on object selection). The constraint of 120 GB will remain in effect until the performance of the SSD-based cache degrades further such that the SSD-based cache later needs additional empty space to sustain a write performance that satisfies the threshold write speed, at which time the reserve capacity is updated according to the process depicted in FIG. 3.

An example of the process depicted in FIG. 3 is illustrated below with reference to Table 3, with reference to the example discussed above with respect to Tables 1 and 2. Assuming the caching system has selected objects B, E, A and C to be written into an empty cache, the remaining capacity after the writing of each object and the write speed associated with the writing of each object is shown in the Table 3 below:

TABLE 3

| | | | Remaining | Write Speed |
|---|---|---|---|---|
| Obj. ID | Uᵢ | Size (GB) | Capacity (GB) | (MB/s) |
| B | 5 | 30 | 50 | 150 |
| E | 4 | 5 | 45 | 120 |
| A | 3 | 20 | 25 | 80 |
| C | 2 | 25 | N/A | N/A |

In this example, the minimum acceptable write speed is set to 100 MB/s. Because the write speed for object A fell below the minimum acceptable write speed, the system sets the remaining capacity before object A was written—i.e., 45 GB—as the reserve capacity, and any objects ranked lower than object A are not written to the cache (in this case object C). The reserve capacity places a constraint on future write cycles that limits the cumulative size of objects to be stored on the cache as 35 GB. In other words, 45 GB are reserved as empty space for the cache to ensure optimal write performance.

The processes depicted in FIGS. 2 and 3 can be performed periodically to update the contents of the cache. In selecting the interval at which the processes are performed, the system operator chooses between a tradeoff of accuracy in predictions versus additional system load in terms of write/delete cycles and calculation load. These processes may also be performed in response to some trigger, for example, a command to update the contents of an SSD-based cache received at a controller associated with the cache.

It will thus be appreciated that embodiments of the invention provide for optimization of the performance of SSD-based caches by using a utility measure based on content popularity estimations (with consideration of uncertainties associated therewith as error bounds), which is, for example, particularly suitable for video content applications when leveraging a content popularity prediction algorithm specifically designed to be accurate when analyzing the expected popularity of video content. The invention achieves extension of SSD-based cache lifetime by minimizing the number of write operations and improvement of write performance by determining a close-to-optimal amount of space to leave unused in an SSD-based cache.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for caching using a solid-state drive (SSD)-based cache, the method comprising:
determining, by a controller, a set of potential objects for storage at the SSD-based cache;
ranking, by the controller, the potential objects for storage based on a respective expected utility value corresponding to each potential object for storage;
selecting, by the controller, objects for storage from the potential objects for storage based on the ranking;
causing, by the controller, the selected objects to be written to the SSD-based cache.

2. The method according to claim 1, further comprising:
determining, for a first object, a first write speed corresponding to the writing of a first object to the SSD-based cache, wherein the first write speed is above a minimum write speed threshold;
determining a second write speed corresponding to the writing of a second object to the SSD-based cache, wherein the second write speed is below the minimum write speed threshold; and
determining, based on the determination of the second write speed, a reserve capacity for the SSD-based cache.

3. The method according to claim 2, wherein after determining the reserve capacity for the SSD-based cache, a future selection of objects for storage at the SSD-based cache is constrained by the reserve capacity.

4. The method according to claim 1, wherein selecting the objects for storage is constrained by a size constraint.

5. The method according to claim 4, wherein the size constraint is the capacity of the SSD-based cache.

6. The method according to claim 1, wherein selecting the objects for storage is constrained by a size constraint is based on a latency constraint.

7. The method according to claim 1, wherein the expected utility value for each potential object is based on an expected popularity of the object over a time period.

8. The method according to claim 7, wherein the expected utility value for each potential object is further based on an uncertainty value corresponding to the expected popularity of the object over the time period.

9. The method according to claim 1, further comprising:
before causing the selected objects to be written to the SSD-based cache, causing objects stored on the SSD-based cache that were not selected to be deleted.

10. The method according to claim 9, wherein causing objects stored on the SSD-based cache to be deleted is based on sending TRIM commands to the SSD-based cache.

11. A non-transitory processor-readable medium having processor-executable instructions stored thereon for caching using a solid-state drive (SSD)-based cache, the processor-executable instructions, when executed by a processor, causing the following to be performed:
determining a set of potential objects for storage at the SSD-based cache;
ranking the potential objects for storage based on a respective expected utility value corresponding to each potential object for storage;
selecting objects for storage from the potential objects for storage based on the ranking;
causing the selected objects to be written to the SSD-based cache.

12. The non-transitory processor-readable medium according to claim 11, wherein the processor-executable instructions, when executed by the processor, further cause the following to be performed:
determining, for a first object, a first write speed corresponding to the writing of a first object to the SSD-based cache, wherein the first write speed is above a minimum write speed threshold;
determining a second write speed corresponding to the writing of a second object to the SSD-based cache, wherein the second write speed is below the minimum write speed threshold; and
determining, based on the determination of the second write speed, a reserve capacity for the SSD-based cache.

13. The non-transitory processor-readable medium according to claim 11, wherein after determining the reserve capacity for the SSD-based cache, a future selection of objects for storage at the SSD-based cache is constrained by the reserve capacity.

14. The non-transitory processor-readable medium according to claim 11, wherein selecting the objects for storage is constrained by a size constraint.

15. The non-transitory processor-readable medium according to claim 14, wherein the size constraint is the capacity of the SSD-based cache.

16. The non-transitory processor-readable medium according to claim 11, wherein the selecting the objects for storage is constrained by a latency constraint.

17. The non-transitory processor-readable medium according to claim 11, wherein the expected utility value for each potential object is based on an expected popularity of the object over a time period.

18. The non-transitory processor-readable medium according to claim 17, wherein the expected utility value for each potential object is further based on an uncertainty value corresponding to the expected popularity of the object over the time period.

19. The non-transitory processor-readable medium according to claim 11, wherein the processor-executable instructions, when executed by the processor, further cause the following to be performed:
before causing the selected objects to be written to the SSD-based cache, causing objects stored on the SSD-based cache that were not selected to be deleted.

20. The non-transitory processor-readable medium according to claim 19, wherein causing objects stored on the SSD-based cache to be deleted is based on sending TRIM commands to the SSD-based cache.
